(19) United States
(12) Patent Application Publication
(10) Pub. No.: US 2010/0214718 A1
(43) Pub. Date: Aug. 26, 2010

(54) MAGNETIC CAPACITOR

(76) Inventor: Chia-Fu Yeh, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/701,598

(22) Filed: Feb. 7, 2010

Related U.S. Application Data
(60) Provisional application No. 61/155,130, filed on Feb. 24, 2009.

(51) Int. Cl. H01G 4/008

(52) U.S. Cl. 361/305

(57) ABSTRACT

A magnetic capacitor comprises a dielectric layer having a first surface and a second surface opposed to the first surface, a first electrode disposed on the first surface of the dielectric layer and a second electrode disposed on the second surface of the dielectric layer. The first electrode has a plurality of first magnetic dipoles with a same first direction, and the first direction of the first magnetic dipoles is perpendicular to the dielectric layer.

### CROSS REFERENCE TO RELATED APPLICATIONS

This application claims the benefit of U.S. Provisional Application Ser. No. 61/155,130, filed Feb. 24, 2009.

### BACKGROUND OF THE INVENTION

1. Field of the Invention

The present invention relates to a magnetic capacitor, and more particularly, to a magnetic capacitor with an electrode having magnetic dipoles perpendicular to a dielectric layer of the magnetic capacitor.

2. Description of the Prior Art

Capacitors are widely used in electronic circuits to block the flow of direct current while allowing alternating current to pass, and can be used as energy storage apparatuses in electronic devices. Please refer to FIG. 1, which is a schematic diagram illustrating a cross-sectional view of a conventional capacitor. As shown in FIG. 1, the conventional capacitor 10 includes two electrodes 12, 14 and a dielectric layer 16, and the dielectric layer 16 is disposed between the electrodes 12, 14. The dielectric layer 16 is composed of an insulator, such as vacuum, water or aluminum oxide etc. The electrodes 12, 14 are composed of conductive materials, such as metal.

However, in contrast to batteries, the energy storage of the conventional capacitor is rather small. And, when energy storage capacity of the conventional capacitor should be increased, the size and the weight of the conventional capacitor have to be increased accordingly. The volume and the weight of the electronic device including the conventional capacitor are therefore enlarged. For this reason, the application of the conventional capacitor is limited. To increase the capacitance of the conventional capacitor under a fixed size is an important objective in the industry.

### SUMMARY OF THE INVENTION

It is therefore an objective to provide a magnetic capacitor with an electrode having magnetic dipoles perpendicular to a dielectric layer to increase a capacitance of the magnetic capacitor.

According to the present invention, a magnetic capacitor is disclosed. The magnetic capacitor comprises a dielectric layer having a first surface and a second surface opposed to the first surface, a first electrode disposed on the first surface of the dielectric layer and a second electrode disposed on the second surface of the dielectric layer. The first electrode has a plurality of first magnetic dipoles with a same first direction, and the first direction of the first magnetic dipoles is perpendicular to the dielectric layer.

The magnetic capacitor of the present invention disposes one electrode having magnetic dipoles with a same direction on the dielectric layer, and utilizes the magnetic dipoles to generate the magnetic field. Thus, the dielectric layer can be applied with the magnetic field, and due to the magnetic field, the permittivity of the dielectric layer can be increased. The capacitance of the magnetic capacitor can be therefore increased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a cross-sectional view of a conventional capacitor.

FIG. 2 is a schematic diagram illustrating a cross-sectional view of a magnetic capacitor according to a first preferred embodiment of the present invention.

FIG. 3 is a schematic diagram illustrating a flat magnet.

FIG. 4 is a schematic diagram illustrating a cross-sectional view of a magnetic capacitor according to a second preferred embodiment of the present invention.

FIG. 5 is a schematic diagram illustrating a cross-sectional view of a magnetic capacitor according to a third preferred embodiment of the present invention.

FIG. 6 is a schematic diagram illustrating a cross-sectional view of a magnetic capacitor according to a fourth preferred embodiment of the present invention.

FIG. 7 is a schematic diagram illustrating a cross-sectional view of a magnetic capacitor according to a fifth preferred embodiment of the present invention.

FIG. 8 is a schematic diagram illustrating a cross-sectional view of a magnetic capacitor according to a sixth preferred embodiment of the present invention.

FIG. 9 is a schematic diagram illustrating an equivalent circuit for the second preferred embodiment shown in FIG. 4.

FIG. 10 is a schematic diagram illustrating a relation between a ratio of real parts of a permittivity of the second preferred embodiment to real parts of a permittivity without magnetic field and a frequency.

### DETAILED DESCRIPTION

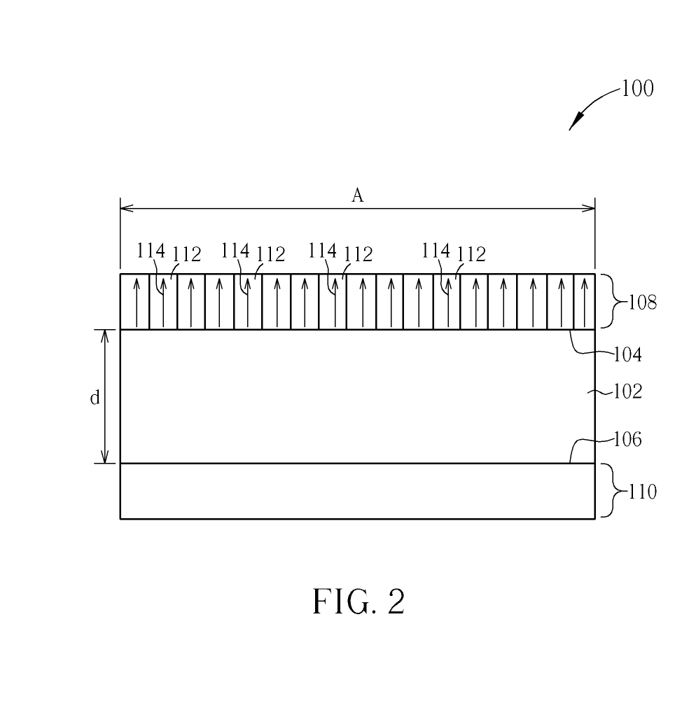

Please refer to FIG. 2, which is a schematic diagram illustrating a cross-sectional view of a magnetic capacitor according to a first preferred embodiment of the present invention. As shown in FIG. 2, the magnetic capacitor 100 of this embodiment includes a dielectric layer 102 having a first surface 104 and a second surface 106 opposed to the first surface 104, a first electrode 108 disposed on the first surface 104 of the dielectric layer 102, and a second electrode 110 disposed on the second surface 106 of the dielectric layer 102. The second electrode 110 is parallel to the first electrode 108. In this embodiment, the first electrode 108 includes a plurality of first magnetic sections 112, and is composed of a magnetic material with conductivity, such as alloy of Fe and Pt, alloy of Co and Pt, or a combination thereof. Thus, the first electrode 108 has a plurality of first magnetic dipoles 114, and each first magnetic section 112 respectively has each first magnetic dipole 114. The first magnetic dipoles 114 have a same first direction indicated by arrows as shown in FIG. 2, and the first direction of the first magnetic dipoles 114 is perpendicular to the dielectric layer 102, The first electrode 108 therefore generates a magnetic field applying to the dielectric layer 102 close to the first electrode 108, and the magnetic field generated by the first electrode 108 is perpendicular to an interface between the first electrode 108 and the dielectric layer 102. When the first electrode is composed of alloy of Fe and Pt or alloy of Co and Pt, the first electrode with the first magnetic dipoles perpendicular to the dielectric layer is formed by a sputtering process.

Furthermore, the second electrode 110 of this embodiment is a conductive layer, which is composed of a conductive material without magnetism, such as Pt or other conductive metal. The dielectric layer 102 can be composed of a dielectric material selected from silicon dioxide, titanium dioxide, insulating material, ceramic material, magnetic dielectric material, and a combination thereof, and the dielectric layer 102 can be a single layer structure or a multilayer structure.

In addition, the first electrode 108 is formed by coating or depositing the magnetic material on the dielectric layer 102 through a sputtering process or an IBD (Ion Beam Deposition) process, and then, the first electrode 108 is applied with an external magnetic field and annealed to arrange the first magnetic dipoles 114 of the first electrode 108 orderly. Therefore, the first magnetic dipoles 114 of the first electrode 108 can have the same first direction that is perpendicular to the interface between the first electrode 108 and the dielectric layer 102. Thereafter, the second electrode 110 can be formed on the second surface 106 of the dielectric layer 102 by a deposition process, such as chemical deposition process or phyiscal deposition process. The sputtering process or the IBD process in combination with the annealing process can be performed several times in turn, so that the first electrode 108 can have a thicker thickness. The first electrode 108 can be therefore a multilayer structure. This means that the first electrode 108 can include a plurality of magnetic layers, and the magnetic layers are sequentially formed on the dielectric layer 102. The present invention is not limited to this, and the first electrode 108 can only be a single layer structure. It is noteworthy that the first surface 104 of the dielectric layer 102 is flat, so that the surface of the first electrode 108 that is in contact with the first surface 104 of the dielectric layer 102 is also flat. Moreover, the magnetic field generated by the first electrode 108 is perpendicular to an interface between the first electrode 108 and the dielectric layer 102. Therefore, the electric leakage between the first electrode 108 and the second electrode 110 due to a magnetic capacitor having the uneven dielectric layer can be avoided.

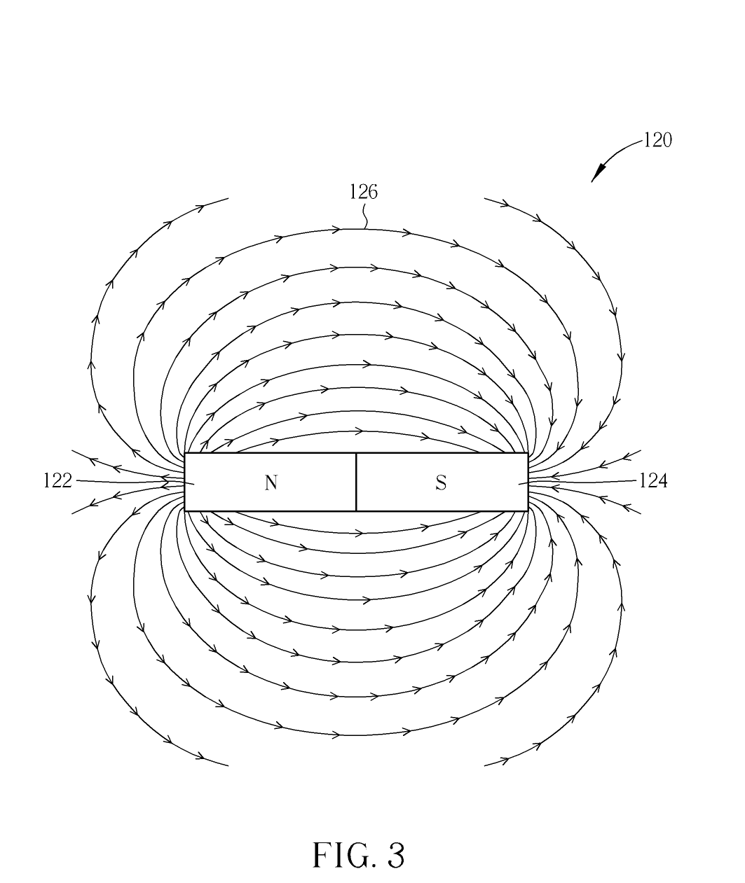

Besides, Please refer to FIG. 3, which is a schematic diagram illustrating a flat magnet. As shown in FIG. 3 and FIG. 2, the flat magnet 120 has a north pole 122 and a south pole 124, and generates magnetic lines 126 from the north pole 122 to the south pole 124. The middle surface of the flat magnet 120 has sparser magnetic lines 126 than the edges of the flat magnet 120, so that the magnetic field close to a border between the north pole 122 and the south pole 124 of the flat magnet 120 is reduced while increasing an area of the flat magnet 120. In this embodiment, because the first direction of the first magnetic dipoles 114 are arranged to be perpendicular to the dielectric layer 102, the magnetic field close to the middle surface of the first electrode 108 will not be reduced, so that the intensity of the magnetic field at the middle of the first electrode 108 relative to the intensity of the magnetic field at an edge of the first electrode 108 do not decrease while increasing an area of the magnetic capacitor 100. The magnetic capacitor 100 can therefore solve the above-mentioned issue. Furthermore, in contrast to the conventional capacitor without the magnetic field, the magnetic field of the magnetic capacitor 100 in this embodiment applying to the dielectric layer 102 can increase a part of permittivity of the dielectric layer 102 close to the first electrode 108. The permittivity of the dielectric layer 102 is therefore increased, and thus, the capacitance of the magnetic capacitor 100 of this embodiment is increased according to the equation:

C=∈A/d,

where C is the capacitance of the magnetic capacitor 100; ∈ is the permittivity of the dielectric layer 102; A is an area of the magnetic capacitor 100; and d is a thickness of the dielectric layer 102.

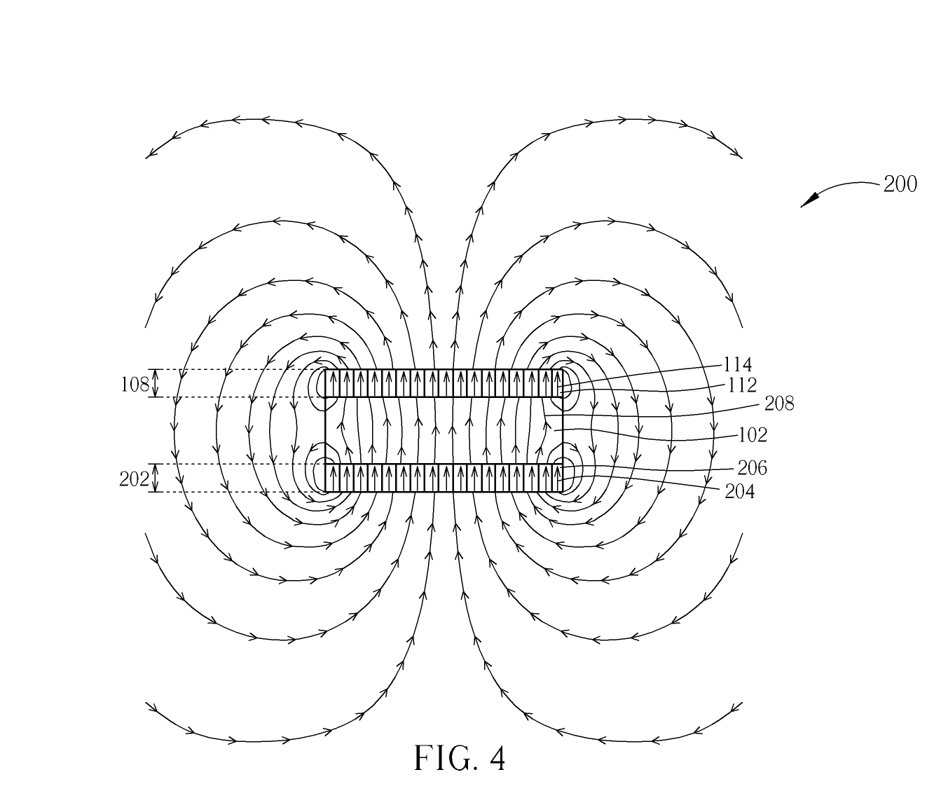

In addition, the second electrode of the present invention is not limited to be composed of a conductive material without the magnetic field and the second electrode also can be composed of a magnetic material with conductivity. Please refer to FIG. 4, which is a schematic diagram illustrating a cross-sectional view of a magnetic capacitor according to a second preferred embodiment of the present invention. In order to compare the difference between the embodiments, structures in the following embodiments which are the same as the first preferred embodiment are assigned the same labels, and same structures will therefore not be described again. As shown in FIG. 4, the second electrode 202 of the magnetic capacitor 200 in this embodiment has a plurality of second magnetic dipoles 204, and the second electrode 202 includes a plurality of second magnetic sections 206. Each second magnetic section 206 is composed of the magnetic material, such as alloy of Fe and Pt, alloy of Co and Pt, or a combination thereof, and each second magnetic section 206 respectively has each second magnetic dipole 204. The second magnetic dipoles 204 have a same second direction, and the second direction of the second magnetic dipoles 204 is the same as the first direction of the first magnetic dipoles 114. The second magnetic dipoles 204 are also interacted with the first magnetic dipoles 114. Thus, in this embodiment, a magnetic line 208 generated by one of the first magnetic dipoles 114 and one of the second magnetic dipoles 204 can be through the dielectric layer 102 and from a north pole of the second magnetic dipole 204 to a south pole of the first magnetic dipole 114. The first electrode 108 and the second electrode 202 both can generate the magnetic field, so that the intensity of the magnetic field applying to the dielectric layer 102 is larger than the intensity of the magnetic field in the first embodiment. Accordingly, the permittivity of the dielectric layer of this embodiment is larger than the permittivity of the dielectric layer 102 of the first preferred embodiment, so that the capacitance of the magnetic capacitor 200 of this embodiment is larger than the capacitance of the magnetic capacitor of the first preferred embodiment.

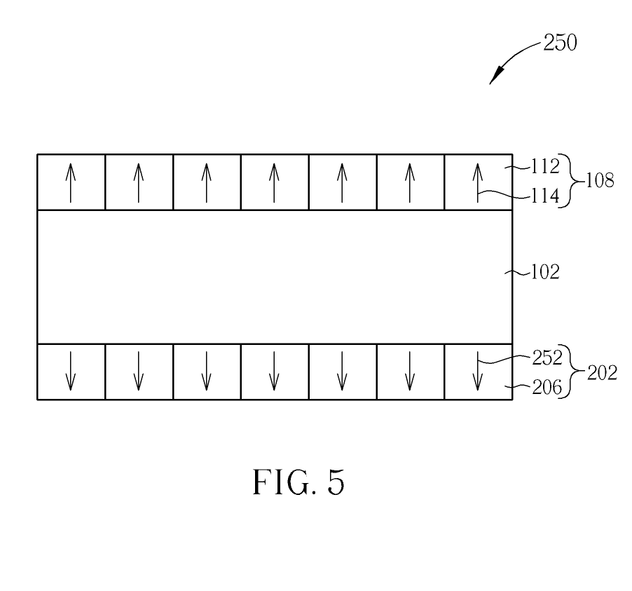

Please refer to FIG. 5, which is a schematic diagram illustrating a cross-sectional view of a magnetic capacitor according to a third preferred embodiment of the present invention. As shown in FIG. 5, as compared with the second preferred embodiment, in the magnetic capacitor 250 of this embodiment, the second direction of the second magnetic dipoles 252 can be an inverse direction of the first direction of the first magnetic dipoles 114.

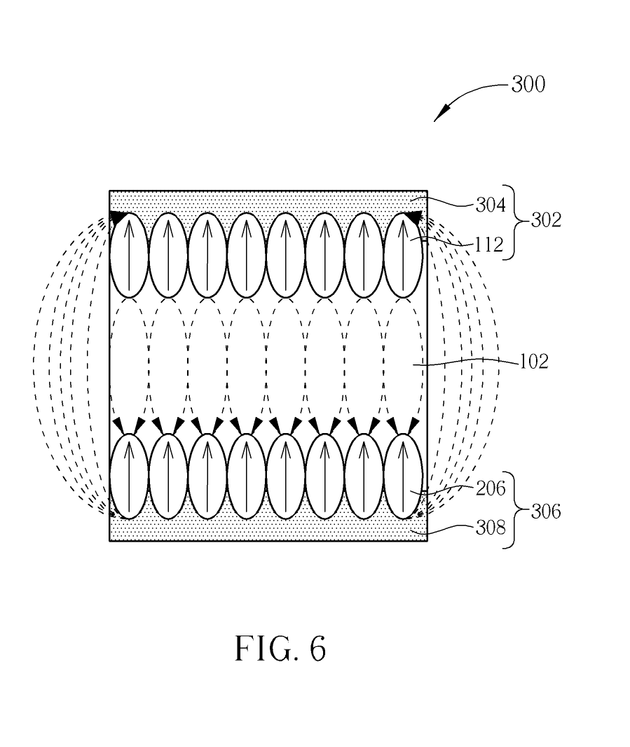

Please refer to FIG. 6, which is a schematic diagram illustrating a cross-sectional view of a magnetic capacitor according to a fourth preferred embodiment of the present invention. As shown in FIG. 6, as compared with the second preferred embodiment, in the magnetic capacitor 300 of this embodiment, the first electrode 302 further includes a first paramagnetic layer 304, and the second electrode 306 further includes a second paramagnetic layer 308. The first magnetic sections 112 are disposed between the first paramagnetic layer 304 and the dielectric layer 102, and the second magnetic sections 206 are disposed between the second paramagnetic layer 306 and the dielectric layer 102. The first paramagnetic layer 304 and the second paramagnetic layer 308 can be constituted by paramagnetic materials, such as Pt, Cr, Mn, etc. In addition, the present invention is not limited that the first electrode and the second electrode both include the paramagnetic layer, and only one of the first electrode and the second electrode can include the paramagnetic layer in the present invention.

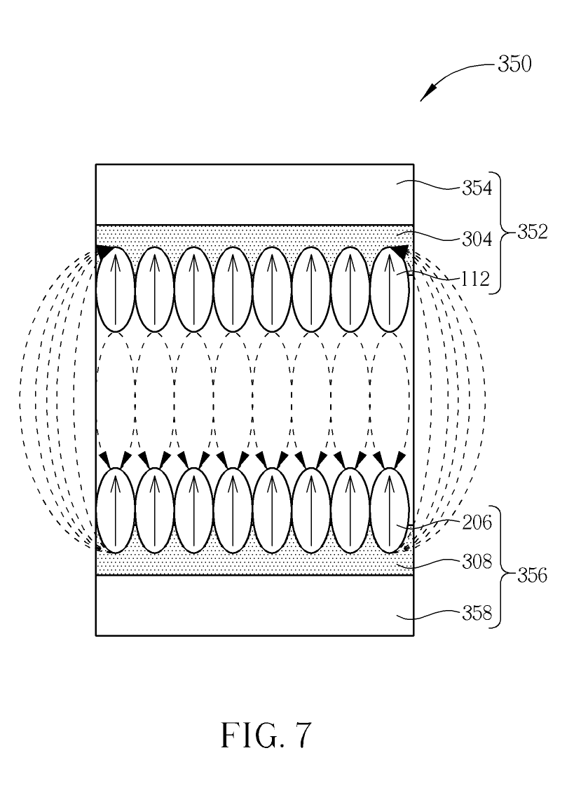

Please refer to FIG. 7, which is a schematic diagram illustrating a cross-sectional view of a magnetic capacitor according to a fifth preferred embodiment of the present invention. As shown in FIG. 7, as compared with the fourth preferred embodiment, in the magnetic capacitor 350 of this embodiment, the first electrode 352 further includes a first conductive layer 354, and the second electrode 356 further includes a second conductive layer 358. The first paramagnetic layer 304 is disposed between the first conductive layer 354 and the dielectric layer 102, and the second paramagnetic layer 308 are disposed between the second conductive layer 358 and the dielectric layer 102. The first conductive layer 354 and the second conductive layer 358 are constituted by conductive materials without magnetism, such as metal. In addition, the present invention is not limited that the first electrode and the second electrode both include the conductive layer, and only one of the first electrode and the second electrode can include the conductive layer in the present invention.

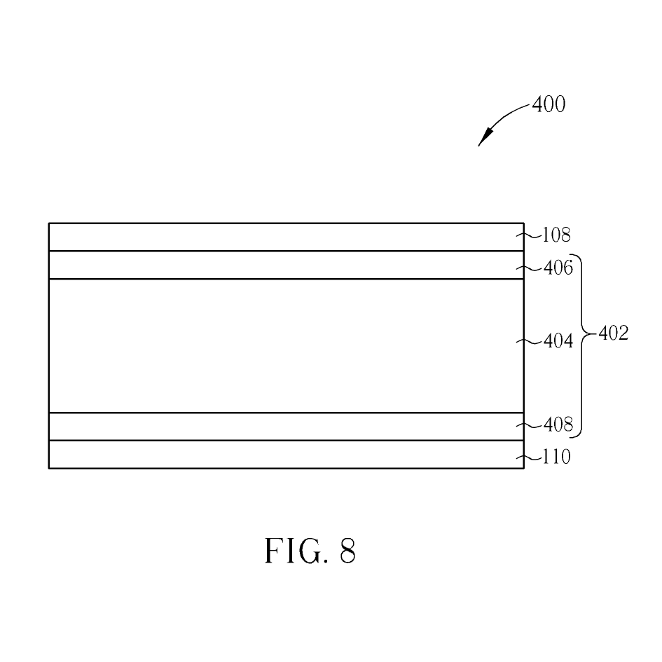

Please refer to FIG. 8, which is a schematic diagram illustrating a cross-sectional view of a magnetic capacitor according to a sixth preferred embodiment of the present invention. As shown in FIG. 8, as compared with first preferred embodiment, the dielectric layer 402 of the magnetic capacitor 400 in this embodiment can be a multilayer structure, and includes a first dielectric layer 404 and two second dielectric layers 406, 408, and the first dielectric layer 404 is disposed between the second dielectric layers 406, 408. The first dielectric layer 404 can be composed of silicon oxide or materials with high permittivity, so that leakage current passing through the dielectric layer 402 can be avoided. The second dielectric layers 406, 408 can be composed of magnesium oxide (MgO) or LSMO (La_{(y)}Sr_{(1-y)}MnO₃), such as La_{0.7}Sr_{0.3}MnO₃, PZT (Pb(Zr_{(y)}Ti_{(1-y)})O₃, such as Pb(La_{0.52}Ti_{0.48})O₃, so that the second dielectric layers 406, 408 can have interaction with the first magnetic sections. Thus, the capacitance of the magnetic capacitor 400 can be further increased. The dielectric layer 402 of the present invention is not limited to only have three layers, and can have a plurality of layers.

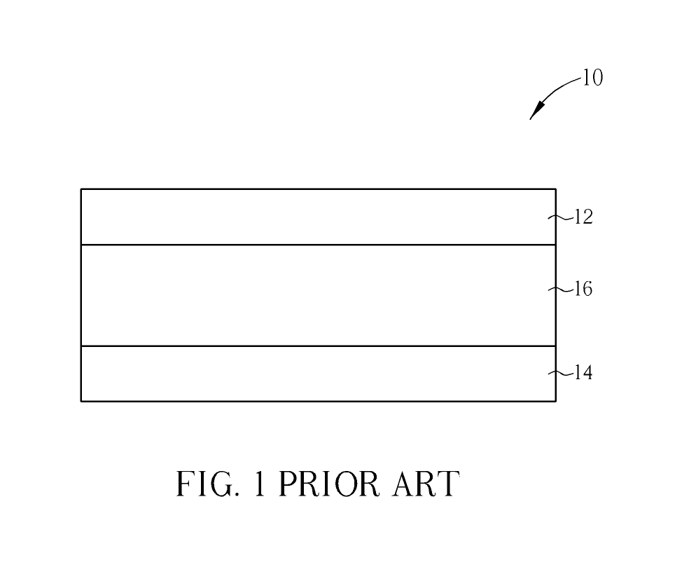

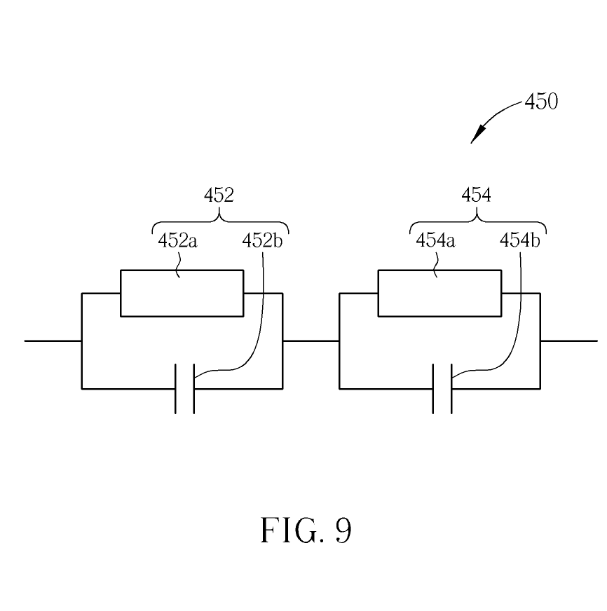

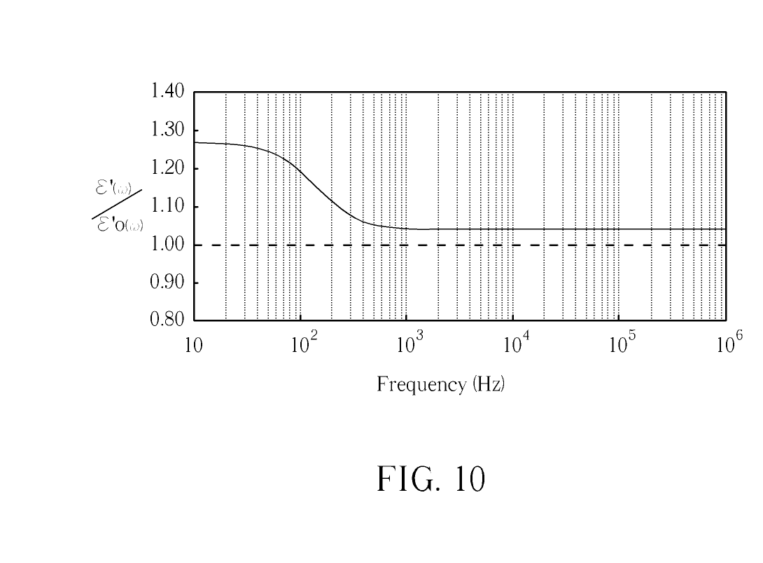

In order to prove the affect of the magnetic field to the permittivity, the following description takes the second preferred embodiment as an example to show that a permittivity of a magnetic capacitor with magnetic field is larger than a permittivity of a magnetic capacitor without magnetic field. Please refer to FIG. 9 and FIG. 10, and refer to FIG. 1 and FIG. 4 again. FIG. 9 is a schematic diagram illustrating an equivalent circuit for the second preferred embodiment shown in FIG. 4. FIG. 10 is a schematic diagram illustrating a relation between a ratio of a real part of a permittivity of the second preferred embodiment to a real part of a permittivity without the magnetic field and a frequency. As shown in FIG. 9, FIG. 1 and FIG. 4, due to the affection of the first electrode 108 and the second electrode 202 generating magnetic field, the dielectric layer 102 can be divided into two parts that respectively are a bulk part and an interfacial part, and the interfacial part is a part of the dielectric layer 102 affected by the magnetic field of the first electrode 108 and the second electrode 202. Therefore, the magnetic capacitor 200 of the second preferred embodiment can be represented by an equivalent circuit 450 that is a serial circuit of the bulk part 452 and the interfacial part 454. A bulk resistor 452a and a bulk capacitor 452b of the bulk part 452 are electrically connected in parallel, and an interfacial resistor 454a and an interfacial capacitor 454b of the interfacial part 454 are electrically connected in parallel. According to Maxwell-Wagner Model, an impedance Z of the magnetic capacitor can be derived to be the following equation.

$$Z = [ \frac{Rb}{1 + {ω}^{2} {Cb}^{2} {Rb}^{2}} + \frac{Ri}{1 + {ω}^{2} {Ci}^{2} {Ri}^{2}} ] + j [ \frac{- ω {CbRb}^{2}}{1 + {ω}^{2} {Cb}^{2} {Rb}^{2}} + \frac{- ω {CiRi}^{2}}{1 + {ω}^{2} {Ci}^{2} {Ri}^{2}} ] ,$$

where Z is the impedance of the magnetic capacitor 200; ω is an angular frequency; Rb is a resistance of the bulk resistor 452a; Ri is a resistance of the interfacial resistor 454a; Cb is a capacitance of the bulk capacitor 452b; and Ci is a capacitance of the interfacial capacitor 454b. The second preferred embodiment takes the first electrode 108 and the second electrode 202 being composed of alloy of Fe and Pt and the dielectric layer 102 being composed of magnesium oxide as an example, and the thickness of the dielectric layer 102 in the second preferred embodiment is substantially 200 angstroms. The conventional capacitor 10 without magnetism is taken as a reference, and the first electrode 12 and the second electrode 14 being composed of Pt and the dielectric layer 16 being composed of magnesium oxide are taken as an example. The thickness of the dielectric layer 16 in the reference is substantially 100 angstroms. The real part of the permittivity of the second preferred embodiment is denoted as ∈′(ω), and the real part of the permittivity of the reference is denoted as ∈′₀(ω). As shown in FIG. 10, the ratio of real parts of the permittivity ∈′(ω) of the second preferred embodiment to real parts of the permittivity ∈′₀(ω) of the reference is denoted as ∈′(ω)/∈′₀(ω), and is over 1, so that the permittivity with the magnetic field is larger the permittivity without magnetic field. Therefore, the capacitance of the magnetic capacitor of the second preferred embodiment is substantially 20% larger than the capacitance of the capacitor of the reference. In addition, at the frequency of 0 Hz, the ratio of the permittivity ∈′(ω) of the second preferred embodiment to the permittivity ∈′₀(ω) of the reference is over 1.2. This means that in the second preferred embodiment, the permittivity of the magnetic capacitor in a DC mode of operation is larger than the permittivity in an AC mode of operation.

As the above-mentioned description, the magnetic capacitor of the present invention disposes at least one electrode having magnetic dipoles with a same direction on the dielectric layer and perpendicular to the dielectric layer, and utilizes the magnetic dipoles to generate the magnetic field. Thus, the dielectric layer can be applied with the magnetic field, and due to the magnetic field, the permittivity of the dielectric layer can be increased. The capacitance of the magnetic capacitor can be therefore increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A magnetic capacitor, comprising:
a dielectric layer, having a first surface and a second surface opposed to the first surface;
a first electrode, disposed on the first surface of the dielectric layer, the first electrode having a plurality of first magnetic dipoles, the first magnetic dipoles having a same first direction, and the first direction of the first magnetic dipoles being perpendicular to the dielectric layer; and
a second electrode, disposed on the second surface of the dielectric layer.

2. The magnetic capacitor of claim 1, wherein the first electrode is composed of a magnetic material with conductivity.

3. The magnetic capacitor of claim 2, wherein the magnetic material is an alloy of Fe and Pt or an alloy of Co and Pt.

4. The magnetic capacitor of claim 1, wherein the first electrode comprises a plurality of first magnetic sections, and each first magnetic section respectively has each first magnetic dipole.

5. The magnetic capacitor of claim 4, wherein the first electrode further comprises a first paramagnetic layer, and the first magnetic sections are disposed between the first paramagnetic layer and the dielectric layer.

6. The magnetic capacitor of claim 5, wherein the first electrode further comprises a first conductive layer, and the first magnetic sections are disposed between the first conductive layer and the dielectric layer.

7. The magnetic capacitor of claim 1, wherein the first electrode is a multilayer structure.

8. The magnetic capacitor of claim 1, wherein the second electrode has a plurality of second magnetic dipoles that have a same second direction, and the second electrode is composed of a magnetic material.

9. The magnetic capacitor of claim 8, wherein the second direction of the second magnetic dipoles is the same as the first direction of the first magnetic dipoles.

10. The magnetic capacitor of claim 8, wherein the second direction of the second magnetic dipoles is an inverse direction of the first direction of the first magnetic dipoles.

11. The magnetic capacitor of claim 8, wherein the magnetic material is an alloy of Fe and Pt or an alloy of Co and Pt.

12. The magnetic capacitor of claim 8, wherein the second electrode comprises a plurality of second magnetic sections, and each second magnetic section respectively has each second magnetic dipole.

13. The magnetic capacitor of claim 12, wherein the second electrode further comprise a second paramagnetic layer, and the second magnetic sections are disposed between the second paramagnetic layer and the dielectric layer.

14. The magnetic capacitor of claim 13, wherein the second electrode further comprises a second conductive layer, and the second magnetic sections are disposed between the second conductive layer and the dielectric layer.

15. The magnetic capacitor of claim 8, wherein the second electrode is a multilayer structure.

16. The magnetic capacitor of claim 1, wherein the dielectric layer is a multilayer structure.

17. The magnetic capacitor of claim 16, wherein the dielectric layer comprises a first dielectric layer and two second dielectric layers, and the first dielectric layer disposed between the second dielectric layers.

18. The magnetic capacitor of claim 17, wherein the first dielectric layer is composed of silicon oxide.
